(19) United States
(12) Patent Application Publication
(10) Pub. No.: US 2022/0111491 A1
(43) Pub. Date: Apr. 14, 2022

(54) Process to Enable a Single Person to Work with Elastic Without a Second Person to Hold Said Elastic

(71) Applicant: Sabrina Lee McDowell, Palo Alto, CA (US)

(72) Inventor: Sabrina Lee McDowell, Palo Alto, CA (US)

(21) Appl. No.: 17/066,445

(22) Filed: Oct. 8, 2020

(51) Int. Cl. B25B 9/00

(52) U.S. Cl. CPC B25B 9/00

(57) ABSTRACT

The process allows a person to manipulate and work with a piece of elastic without the aid of a second person to hold said elastic. The process temporarily attaches a piece of elastic to a holder constructed from common crafting materials in a way that allows said elastic to be manipulated including firm pulls and tugs and, when work is completed, allows said elastic to be detached from said temporary holder easily and cleanly.

### CROSS-REFERENCE TO RELATED APPLICATIONS

n/a

### FEDERALLY SPONSORED RESEARCH

n/a

### INCORPORATED BY REFERENCE CD OF SEQUENCE LISTING OR PROGRAM LISTING

n/a

### TECHNICAL FIELD

The present process relates to working with a piece of elastic, and more particularly to temporarily securing or holding a piece of elastic while a person works with said elastic.

### BACKGROUND ART

There are many crafts that work with elastic that either require or is done more easily with one person manipulating the elastic while a second person holds said elastic. An example would be tying something around a piece of elastic. If a second person is not available to hold said elastic, many crafters will attempt to improvise some way of holding said elastic like taping or tying said elastic between 2 chairs or other furniture, or wrapping said elastic around a box. While these alternatives might work some of the time, they are often clumsy: chairs may tip if pulled too tight, tape may come loose, or if the required amount of said elastic is only a few inches, the amount of elastic required to secure to furniture or around an available box might grossly exceed the amount needed in the craft.

An application of the process is crafting a tutu for a clothespin ballerina doll. The clothespin ballerina doll tutu requires multiple strips of tulle net to be tied tightly to a piece of elastic no more than 3 inches long. The process solves the problem of tying the tulle strips to a piece of elastic without the help of an additional person to hold said elastic. The process applied to the clothespin ballerina doll tutu is illustrated in a YouTube video (minute 3:20-3:41) https://www.youtube.com/watch?v=R4rKiO2WvH4&list=PLG8IwTSUeIGZtv9GiO 0XPcir9SgimepSH&index=4. The video demonstrates the process provides a way to hold the elastic firmly while tying tights knots of the tulle net around said elastic and also allows for easy and clean detachment of said elastic when the tulle knots are complete.

### SUMMARY

The process allows a person to work with a pieces of elastic or filament without the aid of a second person to hold said elastic.

### BRIEF DESCRIPTION OF DRAWINGS

FIG. 1 schematically illustrates a piece of elastic temporarily attached to a glass jar using hot glue. The ends of said elastic are secured to the outside rim of said jar using a small dot of hot glue.

### DRAWING REFERENCE NUMERALS

10: glass jar

11: piece of elastic

12: points on jar where said elastic is attached with hot glue

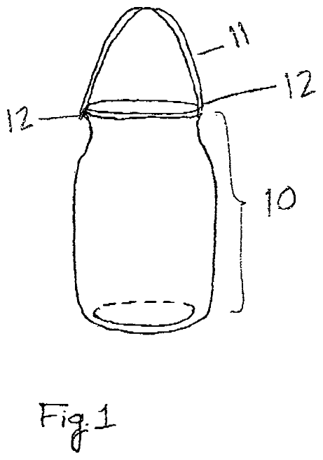

### Detailed Description—FIG. 1—First Embodiment

One embodiment is illustrated by FIG. 1 which shows a glass jar may be used to hold a piece of elastic. Other embodiments may use some other glass or smooth-surfaced, rigid, non-porous container (like a ceramic bowl) instead.

The ends of the piece of elastic are secured to the outside rim of the jar using a small dot of hot glue. As illustrated in the picture, it is not necessary for said elastic to be glued taut, and therefore, it is not necessary to find a jar with an opening that exactly matches the length of said elastic.

### Operation

Once a piece of elastic is attached to a glass jar with hot glue, a single person can manipulate said elastic. The hot glue is strong enough to temporarily hold said elastic when said elastic is manipulated and even pulled upon firmly. The rigid surface also allows said elastic to be manipulated and pulled.

Once work is complete, the elastic can be removed. The smooth, non-porous surface of the jar allows said elastic to be pulled easily and completely, leaving said elastic without any visible adhesive residue.

### Program Codes Listing

n/a

### Conclusions, Ramifications, and Scope

Thus the reader can see, the process for temporarily attaching a piece of elastic to a smooth, nonporous, rigid container, can allow a person to work with elastic without an additional person to hold said elastic.

In addition to a piece elastic, this process can also be used to hold a piece of string, ribbon, or other filament.

Furthermore, the process:
can be done using common crafting materials, and
a allows the elastic to remain free of visible adhesive residue.

What is claimed is:

1. A process for working with elastic or filament with means for holding said elastic or filament without the aid of a second person.

2. A process for working with elastic or filament with means for securing said elastic or filament strongly enough to withstand firm pulls or tugs.

3. A process for temporarily securing a piece elastic or filament with means to leave no adhesive residue on said elastic or filament.

4. A process for attaching tulle strips to a piece of elastic with means to allow one person to work unaided by a second person.
